(19) United States
(12) Patent Application Publication
(10) Pub. No.: US 2023/0059546 A1
(43) Pub. Date: Feb. 23, 2023

(54) Access Control System

(71) Applicant: Mastercard Asia/Pacific PTE. LTD., Singapore (SG)

(72) Inventors: Donghao Huang, Singapore (SG); Weiming Ma, Singapore (SG); Dendy Gunawan, Singapore (SG); Bensam Joyson, Singapore (SG)

(21) Appl. No.: 17/404,498

(22) Filed: Aug. 17, 2021

(51) Int. Cl. G06Q 20/40; G06Q 20/20; H04L 9/32

(52) U.S. Cl. CPC G06Q 20/4014; G06Q 20/405; G06Q 20/202; H04L 9/3213

(57) ABSTRACT

Various implementations described herein are directed to a method for providing access control via an access server. In one implementation, a card or token onboarding request is received from a merchant server. Onboarding is initiated based on the received card or token onboarding request. An access initiation request is received from an access terminal. The access initiation request includes at least a card or token of a consumer. A mapping is created based on the access initiation request. Access is provided via the access terminal, in response to an access request, based on the mapping.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Current access control systems involve the use of physical keys and/or multiple identification cards. Electronic access control grants access based on the credentials presented. Access terminals and accompanying networks should be updated to take advantage of opportunities and diversify service offerings in the electronic access control paradigm.

### SUMMARY

Described herein are various implementations of a method for providing access control via an access server. In one implementation, a card or token onboarding request is received from a merchant server. Onboarding is initiated based on the received card or token onboarding request. An access initiation request is received from an access terminal. The access initiation request includes at least a card or token of a consumer. A mapping is created based on the access initiation request. Access is provided via the access terminal, in response to an access request, based on the mapping.

In one implementation, the access initiation request includes at least card information or a token.

In one implementation, the card information or token can be validated and an application status inquiry (ASI) message can be generated.

In one implementation, the ASI message is forwarded to an issuer via a payment network.

In one implementation, a success message from the issuer is received via the payment network upon a successful matching of the ASI.

In one implementation, a notification of a new access request is provided to the merchant server upon receipt of the success message.

In one implementation, the notification of the new access includes a card identifier or a token identifier and a terminal identifier.

In one implementation, a create access mapping request is received from the merchant server.

In one implementation, the create access mapping request includes the terminal identifier, the card identifier or the token identifier, and a duration.

Described herein are various implementations of a method for providing access control via an access server. In one implementation, an access request is received from an access terminal via a cloud point of sale (CloudPOS) server. Card information or a token received via the access transmission request is validated. A determination is made whether mapping information is available. Access to the access terminal is approved or denied based on an availability of mapping information or an application status inquiry (ASI) transmission result received from an issuer via a payment network.

In one implementation, mapping information is retrieved when mapping information is available.

In one implementation, the mapping is retrieved from a memory of the access server or a storage location accessible by the access server.

In one implementation, an application status inquiry (ASI) is transmitted to the issuer via the payment network.

In one implementation, the ASI transmission result is received from the issuer via the payment network.

In one implementation, the ASI transmission result provides an indication that access via the access terminal can be approved.

In one implementation, the access request is denied if mapping information cannot be retrieved.

Described herein are various implementations of a method for providing access control via a cloud point of sale server. In one implementation, card or token information is received via a user device. An approval process is performed with an access server based on the received card or token information. An access reply received from the access server is provided to an access terminal. The access reply is applied by the access terminal to approve or deny the access request.

In one implementation, the approval process includes: performing a zero dollar authorization transaction via a payment network; and performing a look up of card/token details to approve or deny access via the access server.

Described herein are various implementations of a method for providing access control via a cloud point of sale server. In one implementation, card or token information is received from a service provider. An onboarding process is performed. Upon completion of the onboarding process, an access identifier is received from an access server. The access identifier is provided to an access terminal via the service provider. The access identifier is applied by the access terminal to approve or deny an access request.

In one implementation, the onboarding process includes: validating the card or token information with an issuer; and sending a digital token to the access server.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a diagram of a system for providing access to an entry in accordance with implementations of various techniques described herein.

FIG. 2 illustrates a diagram of a method for providing access control via an access server in accordance with implementations of various techniques described herein.

FIG. 3 illustrates a diagram of an onboarding flow in accordance with implementations of various techniques described herein.

FIG. 4 illustrates a diagram of a method for providing access control via an access server in accordance with implementations of various techniques described herein.

FIG. 5 illustrates a diagram of an access flow in accordance with implementations of various techniques described herein.

FIG. 6 illustrates a diagram of a method for online access in accordance with implementations of various techniques described herein.

FIG. 7 illustrates a diagram of an online access flow in accordance with implementations of various techniques described herein.

FIG. 8 illustrates a diagram of a method for providing offline access in accordance with implementation of various techniques described herein.

FIG. 9 illustrates a diagram of an offline access flow in accordance with implementations of various techniques described herein.

FIG. 10 illustrates a computing system in accordance with implementations of various techniques described herein.

### DETAILED DESCRIPTION

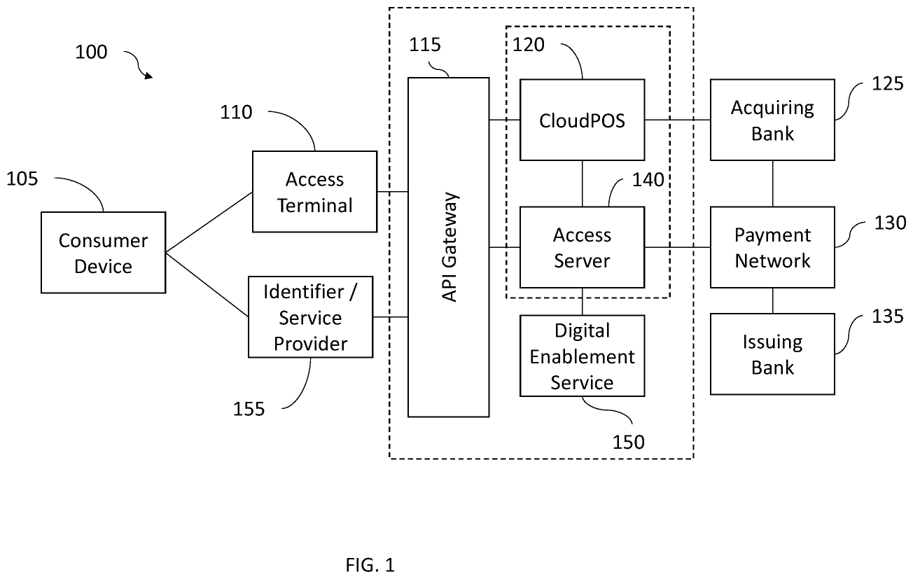

FIG. 1 is a diagram of a system 100 for providing access to an entry.

System 100 may include consumer device 105, access terminal 110, service provider 155, application programming interface (API) gateway 115, cloud-based point of sale server (CloudPOS 120), access server 140, digital enablement service (DES 150), acquiring bank 125, payment network 130, and issuing bank 135. In one implementation, access may be provided via a consumer device 105 directly at an access terminal using an EMV card or digital wallet via access terminal 110. EMV is a payment method based upon a technical standard for smart payment cards and for payment terminals and automated teller machines which can accept them. EMV originally stood for “Europay, Mastercard, and Visa”, the three companies which created the standard. Onboarding may be performed with consumer device 105 having an issuer or merchant application via identifier provider or service provider 155. CloudPOS 120 handles payment transactions, e.g., by exchanging messages with acquiring bank 125, payment network 130 and/or issuing bank 135. Access server 140 handles access transactions, e.g., by communicating with payment network 130, issuing bank 135 and/or DES 150. In addition, CloudPOS 120 can handle access transactions by communicating with access server 140.

In one implementation, a consumer taps a digital card (or a mobile device having a digital wallet) 105 on a door having access terminal 110. Access terminal 110 initiates an EMV access transaction (e.g., using an application status inquiry (ASI)) using API 115. CloudPOS 120 routes the access transaction to access server 140. Access server 140 validates a terminal identifier and token mapping and proceeds with the ASI EMV transaction. If a mapping is not found, an access denial is immediately returned. If a mapping is found, issuer 135 authorizes the transaction and returns the authorization result to access server 140. Access terminal 110 receives the transmission result and opens the door if the transmission result is approved.

In one implementation, door locks are batch provisioned as access terminals and are onboarded to cloudPOS 120 by lock manufacturers where access server 140 is regarded as an acquiring entity. The consumer uses a merchant application to onboard the card or digital token to enable door access. The merchant server, e.g., service provider 155, creates an access mapping in access server 140 using a terminal identifier and card token.

Service provider 155 can be configured as an identifier provider or a service provider. From a system point of view, the access identifier or service provider work similarly.

The identifier provider helps to identify the user of consumer device 105. Registration of user details along with the consumer device details is completed before using this system.

The service provider provides more functionality. The service provider provides the consumer device with multiple services, including as identifier provider. The service provider can also be the owner or manufacturer of access terminal 110. In one implementation, service provider 155 may be a “super app,” where user registration occurs prior to accessing multiple service offerings on consumer device 105.

During access, both identifier/service providers are expected to provide a user identifier. The system will then be able to retrieve user details using this user identifier.

API gateway 115 acts as a single point of communications for access terminal 110 and service provider(s) 155.

As the middleware between these public systems (access terminal 110 and service provider 155) and internal server components (CloudPOS 120 and DES 150), API gateway 115 authenticates the traffic to determine whether: API 115 is communicating with a legitimate source; access terminal 110 and service provide 155 are authorized to be part of the system; and the requests are routed to the correct components.

The ASI is a standard EMV command to inquire about the status of a presented card (or consumer device) at a terminal, e.g., access terminal 110. In system 100, CloudPOS 120 acting as a POS terminal performs an ASI with issuing bank 135 (over payment network 130) to check the card or token presented by consumer device 105 is valid. CloudPOS 120 reads the result of this ASI message, and forwards this result and card details to access server 140 over a HTTP request. (CloudPOS 120 is a web-based server performing as a POS terminal, and is coupled to access server 140 via an IP address).

In digital wallets, e.g., resident on consumer device 105, DES 150 creates a digital token (e.g., with random alphanumeric characters) linked to a payment card for each merchant. The creation of the digital token provides a security feature so that the original payment card details do not have to be stored on consumer device 105 or merchant server 155. This digital token is used in place of the payment card in consumer devices.

When the digital wallet in consumer device 105 is presented to access terminal 110, the digital token is captured by CloudPOS 120. CloudPOS 120 passes this digital token to access server 140. Access server 140 looks up the merchant (or service provider) 155 using the digital token. If found, access server 140 queries DES 150 with the digital token, and DES 150 provides the original card details.

In one implementation, API gateway 115, CloudPOS 120, access server 140, and DES 150 are assets belonging to the same organization and running within an internal network of the organization, behind firewall rules at API gateway 115. In this implementation server components of the organization are built and deployed on the internal network of the organization. API gateway 115 is the gateway for all applications hosted by the organization. In one implementation, CloudPOS 120 and access server 140 can be isolated from other applications on the internal network of the organization, as a form of security. In one implementation, DES 150 is a digital tokenization service for other apps within the network owned by the organization that can also serve access server 140.

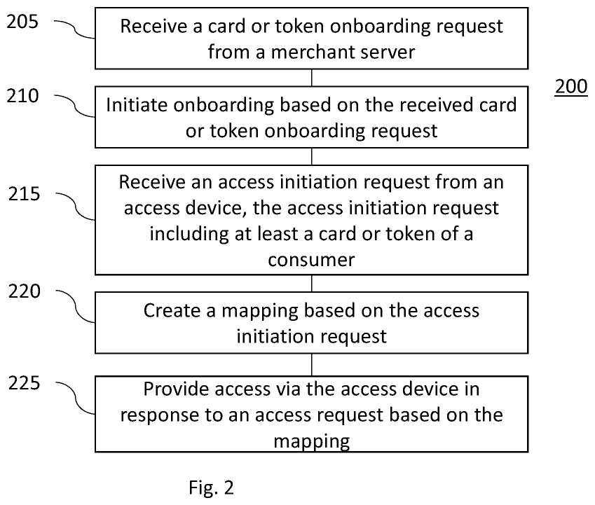

FIG. 2 is a diagram of a method 200 for providing access control via an access server. New card/token onboarding is initiated by consumer device 105 via a merchant application on the consumer device 105. A request for onboarding is forwarded from the merchant application to merchant server, e.g., identifier provider or service provider 155. At block 205, a card or token onboarding request is received by access server 140 from merchant server 155. At block 210, onboarding is initiated based on the received card or token onboarding request. Once onboarding is initiated, the card or mobile device 105 of the consumer can be tapped on, or placed in proximity to, access terminal 110 to initiate an access request, e.g., using near field communication (NFC) techniques. At block 215, an access initiation request is received by access server 140 from access terminal 110. In one implementation, the access request is received from access terminal 110 via CloudPOS server 120. The access initiation request includes at least card information (card number or primary account number (PAN)) or a token associated with an account of the consumer. Access server 140 validates the token/PAN received and generates an application status inquiry (ASI) message. The ASI message is forwarded to issuer 135 via payment network 130. Upon a successful matching of the ASI, access server 140 receives a success message from issuer 135 via payment network 130. Upon receipt of the success message, access server 140 provides a notification of a new access request to merchant server 155. The notification of the new access includes the card/token identifier (card/token ID) and the terminal identifier (terminal ID). Merchant server 155 provides a notify request to the merchant application running on consumer device 105. The notify request includes the card/token ID and a lock ID. Via the merchant application, the consumer approves access for the card/token. The access approved by the consumer can include a duration. The merchant application forwards an approve access message to the merchant server. The approve access message includes the lock ID, the card/token ID and the duration. Access server 140 receives a create access mapping request from merchant server 155. The create access mapping request includes the terminal ID (the lock ID), the card/token ID and the duration. At block 220, a mapping is created based on the access initiation request. Access can be provided via access terminal 110, in response to an access request, based on the mapping.

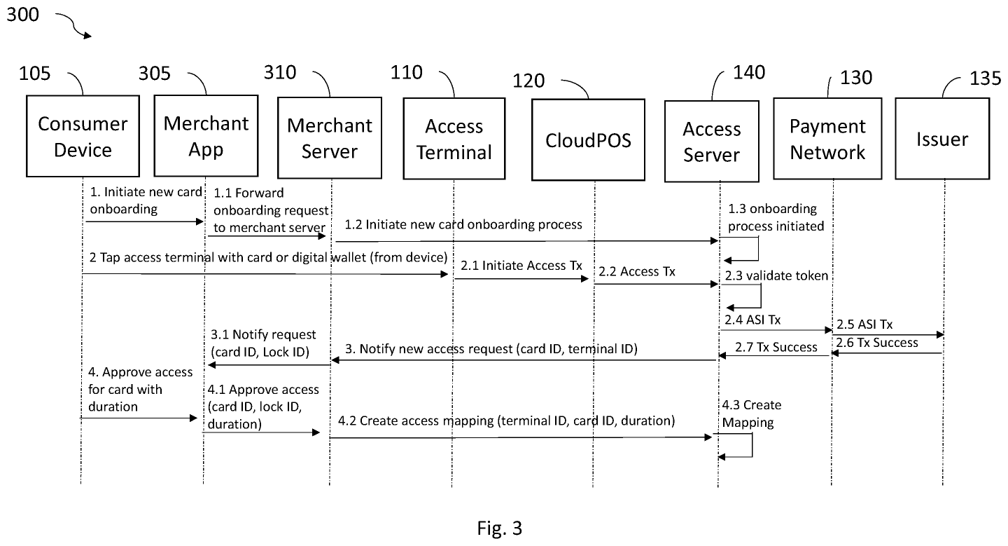

FIG. 3 is a diagram 300 of an onboarding flow according to one implementation. At item 1, new card/token onboarding is initiated e.g., by consumer device 105 via a merchant application 305 on consumer device 105. At item 1.1, a request for onboarding is forwarded from merchant application 305 to merchant server 310. At item 1.2, a new card or token onboarding request is received by access server 110 from merchant server 310 (i.e., the merchant server sends a request to initiate a new card onboarding process). At item 1.3, onboarding is initiated based on the received card or token onboarding request. Once onboarding is initiated, at item 2, the card or mobile device 105 of the consumer can be tap on (or placed near) access terminal 110 to initiate an access request, e.g., using near field communication (NFC) techniques. At item 2.1, access terminal 110 initiates an access request/transmission and sends the access request to CloudPOS server 120. At item 2.2, the initiated access request is received by access server 140 from CloudPOS server 120. The access initiation request includes at least card information (e.g., a primary account number (PAN), a card number or a token) of a consumer. Access server 140 validates the token/PAN received at item 2.3 and generates an application status inquiry (ASI) message. At items 2.4 and 2.5, the ASI message is forwarded to issuer 135 via payment network 130. Upon a successful matching of the ASI, access server 140 receives a success message from issuer 135 via payment network 130 at items 2.6 and 2.7. Upon receipt of the success message, access server 140 provides a notification of a new access request to merchant server 310 at item 3. The notification of the new access includes the card/token identifier (card/token ID) and the terminal identifier (terminal ID). At item 3.1, merchant server 310 provides a notify request to merchant application 305. The notify request includes the card/token ID and a lock ID. At item 4, via merchant application 305, the consumer approves access for the card/token. The access approved by the consumer can include a duration. At item 4.1, merchant application 305 forwards an approve access message to merchant server 310. The approve access message includes the lock ID, the card/token ID and the duration. Access server 140 receives a create access mapping request from merchant server 310 at item 4.2. The create access mapping request includes the terminal ID (the lock ID), the card/token ID and the duration. At item 4.3, a mapping is created by access server 140 based on the access initiation request. Access can be provided via access terminal 110, in response to an access request, based on the mapping.

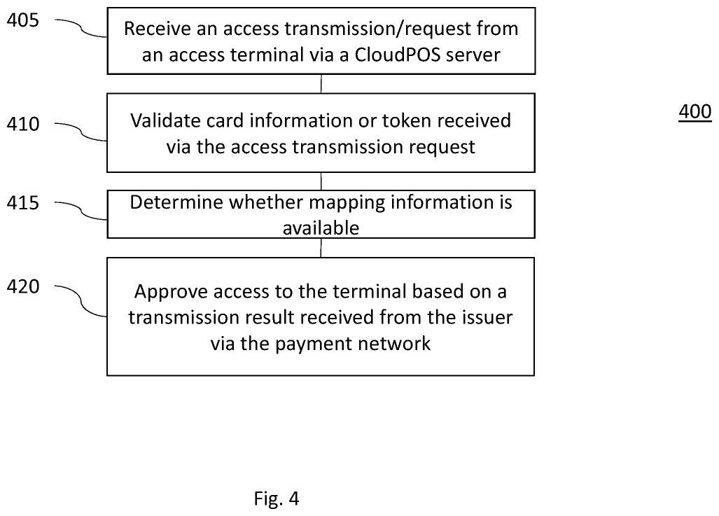

FIG. 4 is a diagram of a method 400 for providing access control via an access server. Access is provided via an access terminal, e.g., access terminal 110, in response to an access request, based on the mapping generated, e.g., in FIG. 2 and FIG. 3. In order to access a location, the consumer taps a card or device on access terminal 110. An initiate access transmission/request is generated by access terminal 110 and forwarded to CloudPOS server 120. At block 405, access server 140 receives the access transmission/request from CloudPOS server 120. At block 410, access server 140 validates the token. At block 415, access server 140 determines whether there is mapping information and, if available, retrieves the mapping. If no mapping is found, the access request is declined. If a mapping is found by access server 140, the mapping is retrieved, e.g., from a memory of access server 140 or a storage location accessible by access server 140. An ASI message is transmitted from access server 140 to issuer 135 via payment network 130. At block 420, approval or denial of access to the access terminal is based on the availability of mapping information or a transmission result (e.g., an ASI transmission result) received from the issuer via the payment network. An ASI transmission result is received by access server 140 from issuer 135 via payment network 130. The ASI transmission result received by access server 140 provides an indication that access via access terminal 110 can be approved. Access server 140 sends an approved or declined message to CloudPOS server 120 based on the availability of mapping information or on the transmission result. CloudPOS server 120 receives the approved or declined message and forwards this message to access terminal 110. Access terminal 110 provides access (e.g., unlocks/opens the door) in response to an approved transmission.

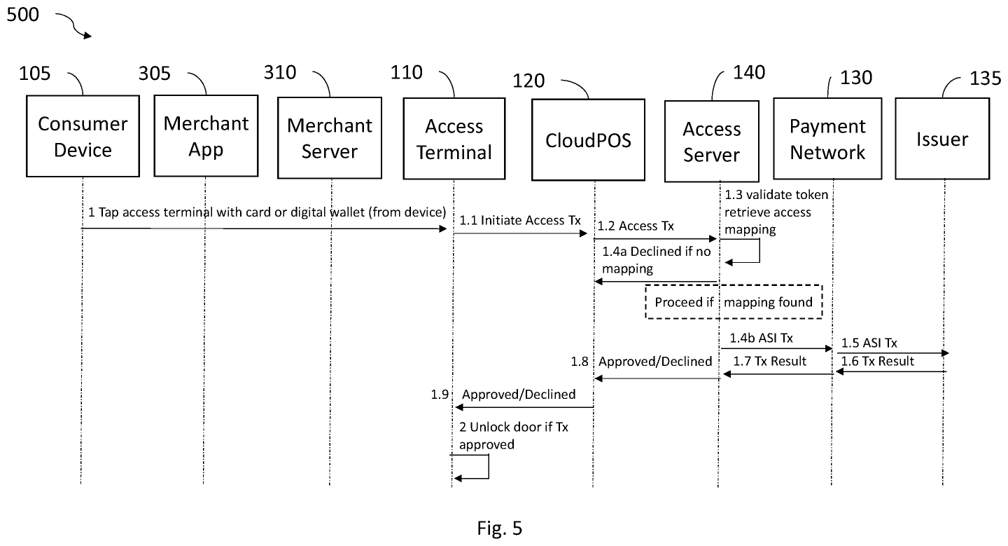

FIG. 5 is a diagram 500 of an access flow according to one implementation. Access is provided via access terminal 110, in response to an access request, based on the mapping generated, e.g., in FIG. 2 and FIG. 3. In order to access a location, at item 1, a card or device 105 is tapped on (or placed near) access terminal 110, e.g., using NFC techniques. At item 1.1, an initiate access transmission/request is generated by access terminal 110 and forwarded to CloudPOS server 120. At item 1.2, access server 140 receives the access transmission/request from CloudPOS server 120. At item 1.3, access server 140 validates the token and retrieves the mapping. If no mapping is found, the access request is declined at item 1.4a. If a mapping is found by access server 140, the mapping is retrieved at item 1.3, e.g., from a memory of access server 140 or a storage location accessible by access server 140. At item 1.4b, an ASI message is transmitted from access server 140 to payment network 130. At item 1.5, payment network 130 transmits the ASI message to issuer 135. At item 1.6, issuer 135 transmits an ASI transmission result to payment network 130 for forwarding to access server 140. At item 1.7, the ASI transmission result is received by access server 140 from issuer 135. The transmission result received by access server 140 provides an indication that access via access terminal 110 can be approved. At item 1.8, access server 140 sends an approved or declined message to CloudPOS server 120.

CloudPOS server 120 receives the approved or declined message and forwards this message, at item 1.9, to access terminal 110. At item 2, access terminal 110 provides access (e.g., unlocks/opens the door) in response to an approved transmission.

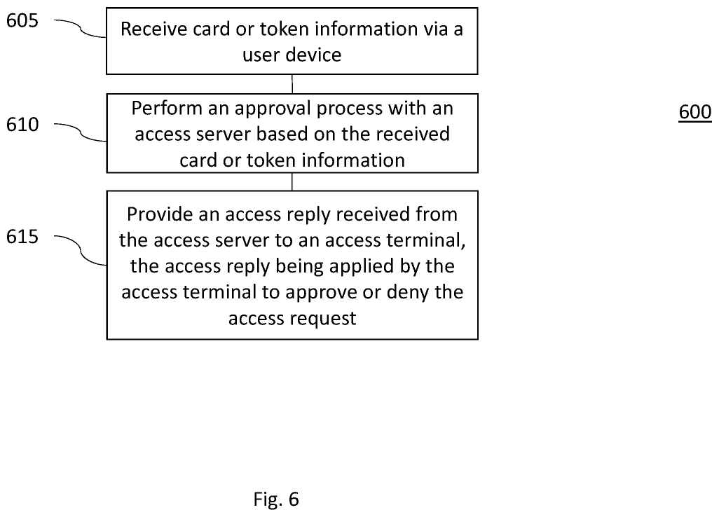

FIG. 6 is a diagram of a method 600 for providing online access. Access control is provided online via cloud POS server 120 and access server 140. Consumer device 105 presents a token at access terminal 110 where personal account number (PAN) and personal account reference (PAR) information is captured by access terminal 110. At block 605, card or token information is received by CloudPOS server 120 from access terminal 110 via consumer device 105. At block 610, an approval process is performed with access server 140 based on the received card or token information. In one implementation, the approval process includes CloudPOS 120 performing a zero dollar authorization transaction via payment network 130. Upon receipt of a transaction success message from payment network 130, CloudPOS 120 performs a look up of card/token details to approve/decline access via access server 140. At block 615, an access reply received from access server 140 is provided to access terminal 110. The access reply is applied by access terminal 110 to approve or deny the access request. Upon receipt of a reply message approving or declining access from access server 140, CloudPOS 120 sends an approve or deny message to access terminal 110 that, in turn, notifies consumer device 105 whether access has been approved or declined.

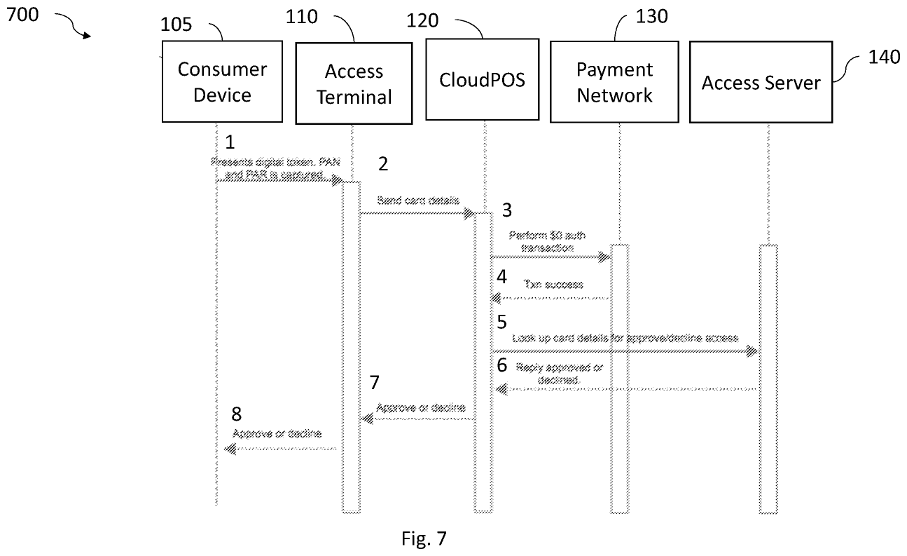

FIG. 7 is a diagram 700 of an online access flow according to one implementation. Access control is provided online via a cloud point of sale server and an access server. At item 1, consumer device 105 presents a token at access terminal 110 where personal account number (PAN) and personal account reference (PAR) information is captured by access terminal 110. At item 2, card or token information is received by CloudPOS server 120 from access terminal 110 via consumer device 105. An approval process is performed with access server 140 based on the received card or token information. In one implementation, the approval process includes CloudPOS 120 performing a zero dollar authorization transaction via payment network 130 at item 3. Upon receipt of a transaction success message from payment network 130 at item 4, CloudPOS 120 looks up card details for approve/decline access via access server 140 at item 5. At item 6, an access reply is received by CloudPOS server 120 from access server 140. At item 7, CloudPOS server 120 provides the access reply to access terminal 110. The access reply is applied by access terminal 110 to approve or deny the access request. Upon receipt of a reply message approving or declining access from access server 110, CloudPOS 120 sends an approve or deny message to the access terminal 110 that, in turn, at item 8, notifies the consumer device 105 whether access has been approved or declined.

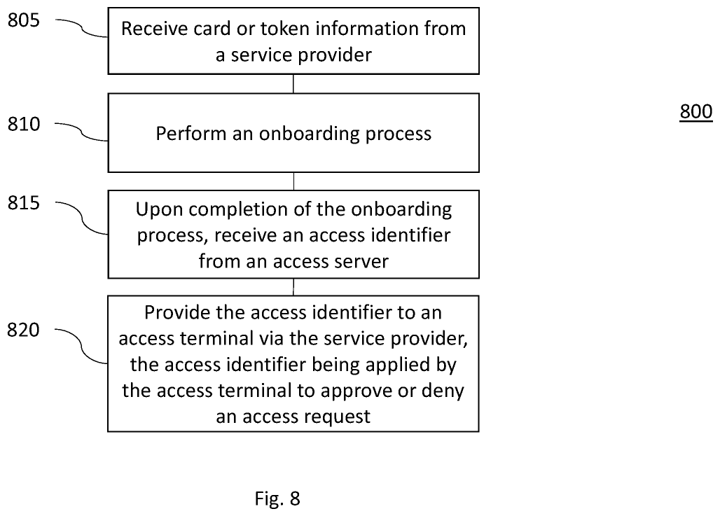

FIG. 8 is a diagram of a method 800 for providing offline access via a CloudPOS server. Access control is provided offline after an onboarding process completed via a cloud point of sale server and an access server. A consumer presents consumer device 105, e.g., an EMV card or mobile device of the consumer, to service provider 155 for onboarding. At block 805, card or token information is received by CloudPOS server 120 from service provider 155. At block 810, an onboarding process is performed by CloudPOS 120. In one implementation, the onboarding process includes CloudPOS server 120 validating the card or token with an issuer, e.g., issuer 135, and sending a digital token to access server 140. The access server maps card details to an access identifier and sends the access identifier to CloudPOS 120. At block 815, CloudPOS 120 receives the access identifier from access server 140 upon completion of the onboarding process. At block 820, CloudPOS 120 forwards the access identifier to service provider 155. Service provider 155 encrypts the access identifier along with access rules and write data (to generate encrypted access information) and sends an onboarding success message to consumer device 105. After the card or token has been onboarded, the consumer presents a card or token to gain access via the access terminal 110. The encrypted access information is then applied by access terminal 110 to validate the card or token and check for access. The access terminal 110 approves or denies the access request based on the validation.

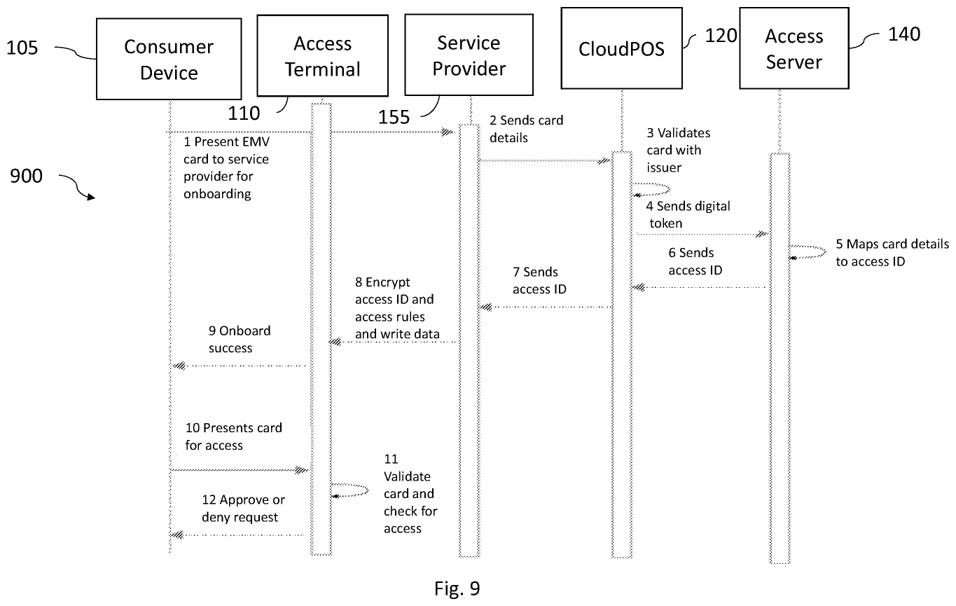

FIG. 9 is a diagram 900 of an offline access flow according to one implementation. Access control is provided offline after an onboarding process completed via a cloud POS server 120 and an access server 140. At item 1, a consumer presents an EMV card or token (via consumer device 105) to service provider 155 for onboarding. At item 2, card or token information is received by CloudPOS server 120 from service provider 155. At item 3, CloudPOS server 120 validates the card or token with issuer, e.g., issuer 135. At item 3, CloudPOS server 120 sends a digital token to access server 140. Access server 140 maps card details to an access identifier at item 5. At item 6, access server 140 sends the access identifier to CloudPOS 120. At item 7, CloudPOS 120 forwards the access identifier to service provider 155. At item 8, service provider 155 encrypts the access identifier along with access rules and write data (to generate encrypted access information). At item 9, service provider 155 sends an onboarding success message to consumer device 105. After the card or token has been onboarded, at item 10, the consumer presents a card or token (using consumer device 105) to gain access via the access terminal 110. The encrypted access information is then applied by access terminal 110 to validate the card or token and check for access at item 11. At item 12, the access terminal 110 approves or denies the access request based on the validation.

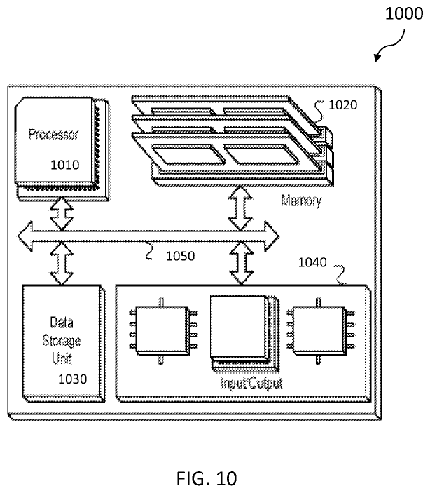

FIG. 10 is a block diagram of a hardware configuration 1000 operable as a device in access system 100. Hardware configuration 1000 may be utilized to implement one or more of elements 105, 110, 115, 120, 125, 130, 135, 140, 150, 155, 305, 310. The hardware configuration 1000 can include a processor 1010, a memory 1020, a storage device 1030, and an input/output device 1040. Each of the components 1010, 1020, 1030, and 1040 can, for example, be interconnected using a system bus 1050. The processor 1010 can be capable of processing instructions for execution within the hardware configuration 1000. In one implementation, the processor 1010 can be a single-threaded processor. In another implementation, the processor 1010 can be a multi-threaded processor. The processor 1010 can be capable of processing instructions stored in the memory 1020 or on the storage device 1030.

The memory 1020 can store information within the hardware configuration 1000. In one implementation, the memory 1020 can be a computer-readable medium. In one implementation, the memory 1020 can be a volatile memory unit. In another implementation, the memory 1020 can be a non-volatile memory unit.

In some implementations, the storage device 1030 can be capable of providing mass storage for the hardware configuration 1000. In one implementation, the storage device 1030 can be a computer-readable medium. In various different implementations, the storage device 1030 can, for example, include a hard disk device/drive, an optical disk device, flash memory or some other large capacity storage device. In other implementations, the storage device 1030 can be a device external to the hardware configuration 1000. The input/output device 1040 provides input/output operations for the hardware configuration 1000. The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing access control via an access server, comprising:
receiving a card or token onboarding request from a merchant server;
initiate onboarding based on the received card or token onboarding request;
receiving an access initiation request from an access terminal, the access initiation request including at least a card or token of a consumer;
creating a mapping based on the access initiation request; and
providing access via the access terminal, in response to an access request, based on the mapping.

2. The method of claim 1, wherein the access initiation request includes at least card information or a token.

3. The method of claim 1, further comprising:
validating the card information or token; and
generating an application status inquiry (ASI) message.

4. The method of claim 3, further comprising:
forwarding the ASI message to an issuer via a payment network.

5. The method of claim 4, further comprising:
receiving a success message from the issuer via the payment network upon a successful matching of the ASI.

6. The method of claim 5, further comprising:
providing a notification of a new access request to the merchant server upon receipt of the success message.

7. The method of claim 6, wherein the notification of the new access includes a card identifier or a token identifier and a terminal identifier.

8. The method of claim 7, further comprising:
receiving a create access mapping request from the merchant server.

9. The method of claim 8, wherein the create access mapping request includes the terminal identifier, the card identifier or the token identifier, and a duration.

10. A method for providing access control via an access server, comprising:
receiving an access request from an access terminal via a cloud point of sale (CloudPOS) server;
validating card information or a token received via the access transmission request;
determining whether mapping information is available; and
approving or denying access to the access terminal based on an availability of mapping information or an application status inquiry (ASI) transmission result received from an issuer via a payment network.

11. The method of claim 10, further comprising:
retrieving mapping information stored in a memory of the access server when mapping information is available.

12. The method of claim 11, wherein the mapping is retrieved from a memory of the access server or a storage location accessible by the access server.

13. The method of claim 11, further comprising:
transmitting an application status inquiry (ASI) to the issuer via the payment network.

14. The method of claim 13, further comprising:
receiving the ASI transmission result from the issuer via the payment network.

15. The method of claim 14, wherein the ASI transmission result provides an indication that access via the access terminal can be approved.

16. The method of claim 10, wherein the access request is denied if mapping information cannot be retrieved.

17. A method for providing access control via a cloud point of sale server, comprising:
receiving card or token information via a user device;
performing an approval process with an access server based on the received card or token information; and
providing an access reply received from the access server to an access terminal, the access reply being applied by the access terminal to approve or deny the access request.

18. The method of claim 17, wherein the approval process comprises:
performing a zero dollar authorization transaction via a payment network; and
performing a look up of card/token details to approve or deny access via the access server.

19. A method for providing access control via a cloud point of sale server, comprising:
receiving card or token information from a service provider;
performing an onboarding process;
upon completion of the onboarding process, receiving an access identifier from an access server; and
providing the access identifier to an access terminal via the service provider, the access identifier being applied by the access terminal to approve or deny an access request.

20. The method of claim 19, wherein the onboarding process comprises:
validating the card or token information with an issuer; and
sending a digital token to the access server.
